(19) United States
(12) Patent Application Publication
(10) Pub. No.: US 2018/0204294 A1
(43) Pub. Date: Jul. 19, 2018

(54) Computer based system and method for developing, managing and distributing mixed media content in the travel services industry

(71) Applicants: Jaivin Anzalota, Groveland, MA (US); Austin Schneider, Martinez, GA (US)

(72) Inventors: Jaivin Anzalota, Groveland, MA (US); Austin Schneider, Martinez, GA (US)

(73) Assignee: Routehappy Inc., Cambridge, MA (US)

(21) Appl. No.: 15/406,328

(22) Filed: Jan. 13, 2017

(51) Int. Cl. G06Q 50/14; G06Q 30/02

(52) U.S. Cl. CPC G06Q 50/14; G06Q 30/0255

(57) ABSTRACT

A computer based system and methods for developing, managing and distributing mixed media content in an eclectic array of product and service attributes in the travel services industry is described herein. The invention is comprised of a Hub with an Application Programming Interface (API) As such its components include a data structure for associating descriptive information, multimedia elements such as photos, videos and tours with product offerings and customer profiles using novel targeting rules that associate the features with specific airline flights, itineraries and customers.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention is a computer based system and method for developing, managing and distributing mixed media content in an eclectic array of product and service attributes in the travel services industry. The invention is comprised of a Hub with an Application Programming Interface (API). As such its components include a data structure for associating descriptive information, multimedia elements (photos, videos and tours) with product offerings and customer profiles using novel targeting rules that associate the features with specific airline flights and itineraries and customers. The invention method further comprises an interface based upon the JSON specification (JavaScript Object Notation). JSON is an open standard format that uses human-readable text to transmit data objects consisting of attribute—value pairs. It is the primary data format used for client/server communication. The invention is further described within the context of the travel services industry but could as easily be applied in other areas where there would be an economic benefit of presenting optional add-on products or services to customers selecting a particular product or service.

Reference patents that speak to the general field of Hubs and APIs and providing an interface between advertisers and prospective customers are noted in the following.

U.S. Pat. No. 8,745,046 B2—Roegner; Michael W., Jun. 3, 2014, entitled: Method and system for selecting content items to be presented to a viewer. This patent discloses systems and methods provided for determining eligible content items. In one example, the determination is based, at least in part, on information about at least one previously presented content item.

U.S. Pat. No. 8,744,911 B2—Rohan; Terrence, et al. Jun. 3, 2014, entitled: Network node ad targeting. This patent assigned to Google, Inc. discloses a computer-implemented method for displaying advertisements to members of a network comprised of identifying one or more communities of members, identifying one or more influencers in the one or more communities, and placing one or more advertisements at the profiles of one or more members in the identified one or more communities.

U.S. Pat. No. 9,077,773 B2—Marietti, et al. Jul. 7, 2015, entitled: Cloud-based hub for facilitating distribution and consumption of application programming interfaces.

U.S. Pat. No. 9,100,719 B2—Ahern, et al. Aug. 4, 2015, entitled: Advertising processing engine service. This patent discloses techniques for an advertising processing engine service to act as an intermediary between client applications and advertising networks.

In the travel industry, it is customary to provide multiple price structures for different levels of services. For example one can purchase a seat on an airline in the coach section or in the first class section. This has expanded to include up-charges for extra baggage, for special seats (as near exit rows), for early boarding privileges, in-flight movies, etc. There are also club privileges at airports. Thus far however, it has not been possible either within the industry or for customers to be presented detailed information about added services or information that is tailored to their specific aircraft, flight and departure or destination locations across all the various places consumers shop for flights.

While it is possible for airlines to present information about their products generally on marketing web pages, it is much more limited across the various points of sale. For example, a major airline is able to market their cabins on their own website, however, they have not been able to do this across other places consumers shop for flights, e.g. KAYAK, Expedia, etc.

### BRIEF SUMMARY

The present invention is part of an over-all system that provides a means for collecting data on flight attributes, storing and analyzing said data and presenting outputs that may be used by integrators in comparing various features of flights including cost, schedule and amenities to address the needs of specific customers.

Novel aspects of this system are described hereinafter as the “Hub” and the “Hub API.” The Hub provides a means for gathering, storing and analyzing disparate data from multiple sources in such a way that it can be accessed and distributed across multiple platforms while conforming to various industry standards. The Hub API is based upon a customized content management platform for travel service providers (e.g. airlines, agents, distributors) to manage and distribute their unique product content, targeted down to individual flights, routes or legs of an itinerary. The Hub API is designed to be an NDC-compatible platform for airline rich content. NDC (New Distribution Capability) is promulgated by the International Air Tariff Association (IATA). It is channel, platform, and delivery agnostic, providing the air travel industry with content and infrastructure it needs to integrate merchandising content into all consumer touch points across all distribution points.

Rich content from the Hub API is created in standardized formats: UTA (Universal Ticket Attribute) and UPA (Universal Product Attribute). UTAs and UPAs drive clicks, engagement, conversion and upsell across airline.com search results, airline confirmation and check-in emails, OTA/metasearch results, GDS (Global Distribution System) travel agent desktops, corporate booking tools and more. Content may be translated into multiple languages. Airlines control permissions by channel.

A method is also provided to create UPAs and decide where the content can appear, giving the service provider full control. Another aspect of the invention is to enable a customer to search on travel arrangements (flights) that have particular amenities or special services.

Each UPA represents a single product attribute with one of more of the following: descriptive text, an icon, photos, videos, tour, and a link to more information. From the provider perspective, one can showcase one's best brand and product attributes down to a single flight or across all flights.

The UTAs are accessible via the top level navigation, allowing one to view UPAs separately from UTAs. The UTA flight view displays UTAs by fare type and category. Fare type input enforces the relationship between cabins, fare brands, and Reservation Booking Designators (RBDs). UTA headlines are derived based on new category-specific metadata attributes.

Methods are also incorporated for applying filters to highlight the different data being viewed, for providing system status messages, for authenticating users and editing user interfaces.

According to a still further aspect of the invention, a computer system for collecting, archiving, analyzing and distributing travel-related information includes a computer and a computer readable medium storing a computer program. The computer program has instructions that causes the computer to retrieve travel-related amenities for all legs of a journey, distribute evaluative sets into composite UTA and UPAs, apply rules to produce raw data that can be exported across multiple platforms and to produce linkages between itineraries and amenities.

The details of one or more implementations are set forth in the accompanying drawings and the description below. Other features, objects, and advantages will be apparent from the description and drawings, specifications and from the claims.

### BRIEF DESCRIPTION OF DRAWINGS

FIG. 1 is a representation of the Hub API Control Panel.

FIG. 2 is a flow diagram of the Hub and the Hub API System showing the relationships between assets in data base, formation of UPAs and UTAs, data sources, Rules Engine, etc.

FIG. 3 is an illustration of the user interface for creating a UPA or UTA.

FIG. 4 is a schematic of the Hub API System indicating relationships between airline specific information, delivery methods and channels of distribution.

FIG. 5 are examples of two UPAs. FIG. 5A is for a Meal-related UPA and FIG. 5B is for a Seat related UPA.

FIG. 6 is an example of a carousel type display of media in a UPA.

FIG. 7 is an example of a user interface for a particular UTA showing capability to edit, disable, etc.

FIG. 8 is a depiction of the development of a UPA with an example of Targeting Rules.

### DETAILED DESCRIPTION OF THE INVENTION

The computer program product and system described herein is designed to be implemented across more than one platform and whose outputs can be viewed in diverse computing systems including but not limited to world wide web/Internet posted web-pages, LANs, dumb terminals, desktop computers, smartphones, laptops, notebooks and the like.

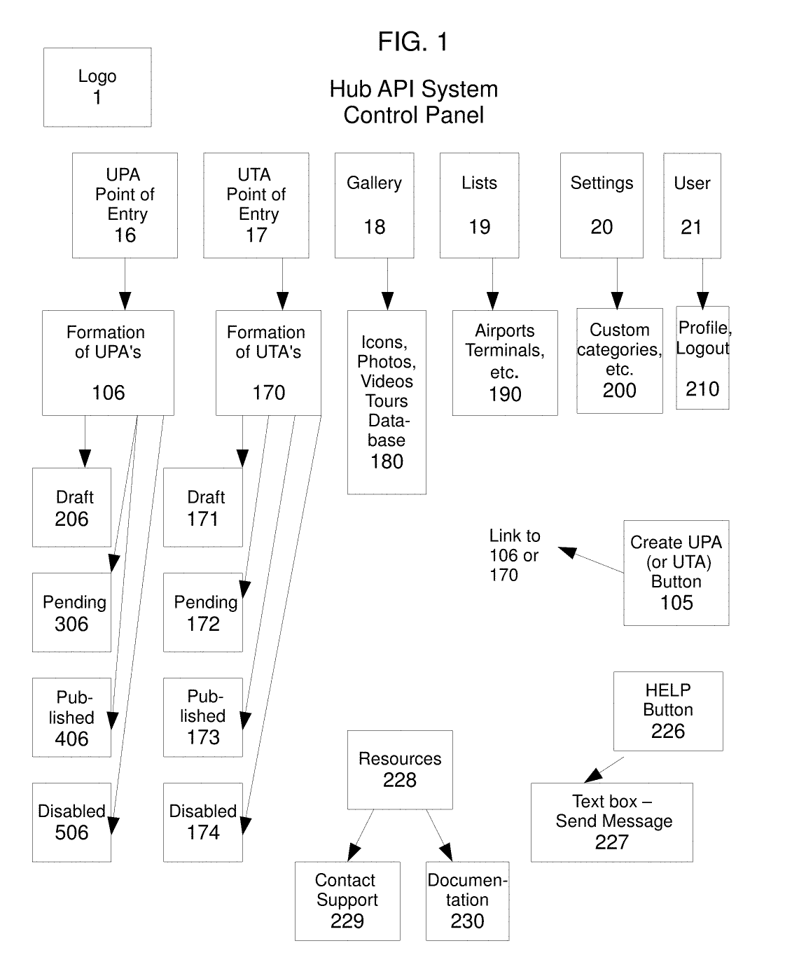

A detailed description of the invention is found in the following. FIG. 1 is one representation of the Control Panel for the Hub and Hub API system. The boxes across the top (16, 17, 18, 19, 20 and 21) are of buttons with hyperlinks to the layers below. Pressing the buttons for the formation of UPAs and UTAs (106 and 170 respectively) opens a screen that facilitates forming a text and image presentation of a particular attribute or amenity. This presentation may then be saved as a draft (206 and 171), as pending (306 and 172), published (406 and 173) or as disabled (506 and 1741. The gallery (18) is comprised of a variety of icons, photos, videos, tours, etc. that can be accessed when creating graphic-rich UPAs and UTAs. Similarly the Lists (19) provide drop down menus from which one may select a particular airport and terminal, etc. The Settings tab (20) provides the means for developing custom categories. A list of the standard categories for UPAs and UTAs is indicated in Table 1 below. By default, every airline is set up with standard categories. These categories are the same across all subscribers, making it easy to share UTAs and UPAs with partners across a common structure.

Other control buttons and links to other screens for resources are indicated and self-explanatory.

TABLE 1a
Standard Categories for UPA and UTA
UPA Categories

| Name | ID |
|---|---|
| Flight | |
| Aircraft | aircraft |
| Seat | seat |
| Meals/beverage | meals-beverage |
| Entertainment | entertainment |
| Power | power |
| Wi-Fi | wi-fi |
| Service (inflight) | service-inflight |
| Upgrade | upgrade |
| Departure | |
| Transport to airport | transport-to-airport |
| Check in | check-in |
| Departure terminal | departure-terminal |
| Departure lounge | departure-lounge |
| Gate & boarding | gate-boarding |
| Service (departure) | service-departure |
| Connection | |
| Stopover | stopover |
| Connecting ease | connecting-ease |
| Connecting terminal | connecting-terminal |
| Connecting lounge | connecting-lounge |
| Service (connecting) | service-connecting |
| Arrival | |
| Baggage collection | baggage-collection |
| Arrival terminal | arrival-terminal |
| Arrival lounge | arrival-lounge |
| Arrival transport | arrival-transport |
| Service (arrival) | service-arrival |
| Airline | |
| Schedule/route | schedule-route |
| Loyalty program | loyalty-program |
| Brand | brand |
| Promotion | promotion |

TABLE 1b
Standard Categories for UTA
UTA Categories

| Name | ID |
|---|---|
| Change | |
| Advance change | advance-change |
| Cancellation | cancellation |
| Same day change | same-day-change |
| Bag | |
| Checked bag allowance | checked-bag-allowance |
| Carry on allowance | carry-on-allowance |
| Seat | |
| Seat selection | seat-selection |
| Upgrade eligibility | upgrade-eligibility |
| Airline | |
| Check in priority | check-in-priority |
| Boarding priority | boarding-priority |
| Lounge access | lounge-access |

### Custom Categories

Provided is a means to set up custom categories (UPAs only) to map to frequent flyer tiers or other airline-specific attributes. There is no limit to the number of categories one can create. Also provided is a means to tag UPAs with multiple custom categories, but note that some integrations may use only the first category assigned. One system feature is that one may add new categories as the need arises and make attempts to consolidate custom categories, if necessary.

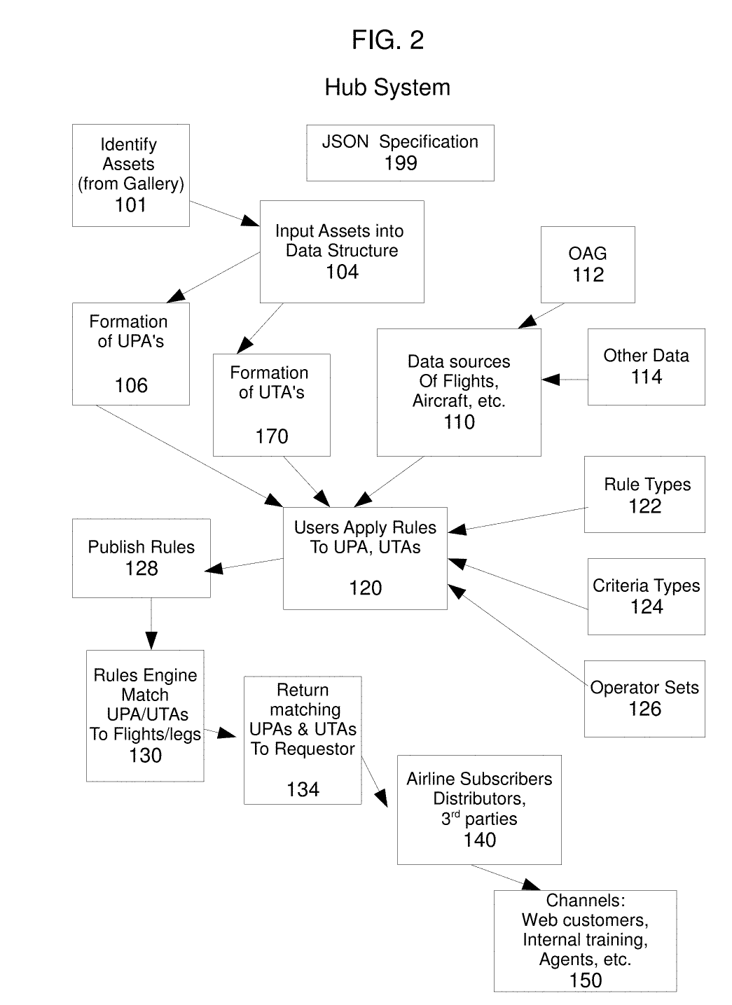

FIG. 2 is a flow diagram of the Hub and the Hub API System showing the relationships between assets in a database, formation of UPAs and UTAs, data sources, rules engine and other components. The inventive method includes the identification of assets (101), typically from the gallery (18) and placing them into a database (104) in such a way that they can be readily accessed by multiple users simultaneously. Also involved is the input of data from the travel industry Official Airline Guide (OAG) (112) and others (110, 114) regarding flights, schedules and aircraft. The OAG is formatted according to the IATA SSIM specification. Another inventive step is the development and application of a set of rules and their application (120) in the formation and application of UTAs (170) and UPAs (106).

All UPAs and UTAs are made up of the same basic elements, including an icon, headline, description, call to action and additional cost values as detailed in Table 2.

TABLE 2
Basic Elements for UPA's and UTA's

| Field | Description | Required |
|---|---|---|
| Icon | An icon used to represent the product | Yes |
| | (minimum size 84 × 84) | |
| Headline | 40-character (max) headline to tease | Yes |
| | the product. Note: UTA headlines are | |
| | generated based on selection from one | |
| | of the predefined category options | |
| Description | 140-character (max) description of the | Yes |
| | product or ticket attribute | |
| Call to | 15-character (max) call to action text | No |
| action | | |
| Call to | External URL paired with the call to | No |
| action | action | |
| URL | | |
| Additional | Free (included in base fare) | No |
| cost | Fee* (available for an additional | |
| | fee above the base price) | |

*Multiple currency fields are provided to support fee information at different points of sale.

An assortment of icons and other media, including video tours to choose from are provided in the Gallery database (180 of FIG. 1)

The associated Hub API provides flexibility in accessing UPAs on demand, across a wide range of channels. Additionally, UPAs can be accessed via third-party integrations to make it easy to get the content where you want it.

The Hub API facilitates the organization of data and information to help create and manage the UPA and UTA assets over time.

To implement the creation of the UPA, typically a member of the product or marketing team leads in defining product attributes and overseeing the development of content with inputs from a copywriter, graphic designer, website developer and others.

The Hub provides a means to capture and convey one's top product attributes and key differentiators such as: investments in flight experience, terminal renovations, or a new booking app—features that may be highlighted on one's website or in press releases. Based upon this data one can start creating UPAs in the Hub. As indicated in FIG. 1, UPAs are initially saved as drafts (206), which can be edited or deleted before publishing to integrators.

There are two possible workflows:
A. Collaborators (users with limited privileges “submit” a UPA or UTA and Super Users (users with full privileges) review and publish the content for distribution to integrators.
B. Super Users simply publish content directly for distribution to integrators.

The invention provides a means whereby one may create or obtain icons that represent each product attribute. A well planned and executed set of icons will make the UPAs more memorable and quickly understood, helping to drive higher click-through and engagement. One may also add photos, videos and video tours to the Hub gallery (180) and associate them with the appropriate UPAs. The system also provides links to videos posted on YouTube or Vimeo. A means is provided such that one only needs to identify the video embed code from those services, not the actual video files or raw source. Once UPAs have been reviewed and finalized they are submitted to the Hub host where they are associated with appropriate flights (using targeting rules) and published (406).

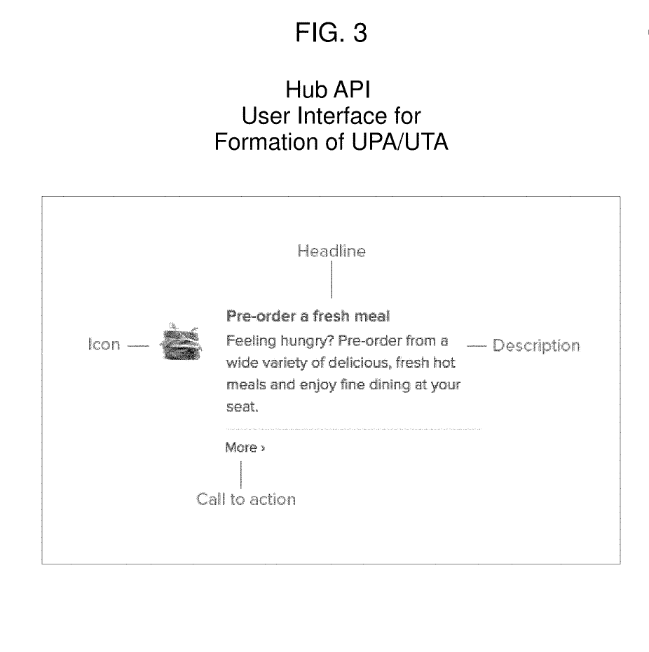

The formation of UPAs and UTAs is further illustrated in FIG. 3, which is a panel that is displayed to the creator of a particular UPA in the Hub API.

Referring again to FIG. 2, other aspects of the Rules generation are the options for Rule Types (122), Criteria Types (124) and Operator Sets (126) as further described below. Upon finalization and publication of the rules (128), they serve as inputs to the Rules Engine (130) that matches them with the UPA/UTAs to the legs of flights under consideration. Matches are returned to the Requestor (134) and distributed to subscribers and others (140) through the appropriate channels (150).

### Targeting Rules

Targeting rules (122) are further detailed in the following text and Table 3. They are the cornerstone of how UPAs and UTAs are associated with flights. Rules are used in conjunction with criteria to create a flexible and powerful targeting system. Using multiple rules together allows for highly specific UPAs, spotlighting precisely what is offered on a flight.

All rules follow a simple syntax of rule type+operator+criteria, e.g.: Arrival airport is in “Bay Area” (Bay Area being a list of several airports). Most rules also support the input of a single value, e.g.: Arrival airport is “SFO.” Rules are additive, meaning each rule builds on the next, making the targeting more and more specific with each new rule. UPAs and UTAs are returned via the Hub API when the targeting criteria defined for a UPA or UTA match the flight(s) requested.

TABLE 3
Available Targeting Rules

| | | Criteria |
|---|---|---|
| Rule | Associates with flights that . . . | format |
| Arrival airport | Arrive at specific airports | List or value |
| Arrival country | Arrive in specific countries | List or value |
| Arrival or departure | Arrive or depart at specific airports | List or value |
| airport | | |
| Arrival or departure | Arrive or depart in specific countries | List or value |
| country | | |
| Arrival time | Arrive before or after a specific time | HH:MM |
| Departure airport | Depart from specific airports | List or value |
| Departure country | Depart from specific countries | List or value |
| Departure terminal | Depart from specific terminals | List or value |
| Departure time | Depart before or after a specific time | HH:MM |
| Flight date | Depart within a date range | Start date to |
| | | end date |
| Flight duration | Have an elapsed time within a range | HH:MM- |
| | | HH:MM |
| Origin & destination | Match a specific set of O&Ds | List or value |
| Subfleet | Are flown on a specific aircraft | List or value |
| | subfleet | |
| Tail | Are flown on a specific aircraft | List |
| | (exact tail number) | |

Criteria types (124) are seen in Table 4.

TABLE 4
Criteria types

Airport
Country
Origin & Destination (O&D)
Subfleet
Tail
Terminal

Targeting criteria are composed by creating lists (19) of airports, countries, O&Ds, subfleets, tails (specific aircrafts), and terminals (airports). Refer to Lists (190) in FIG. 1
Operating Sets (126) in FIG. 2 are indicated in Table 5.

TABLE 5
Operator Sets

(a)
Is in
Is not in
is
Is not
(b)
Is before
Is after
(c)
Is between
Is not between

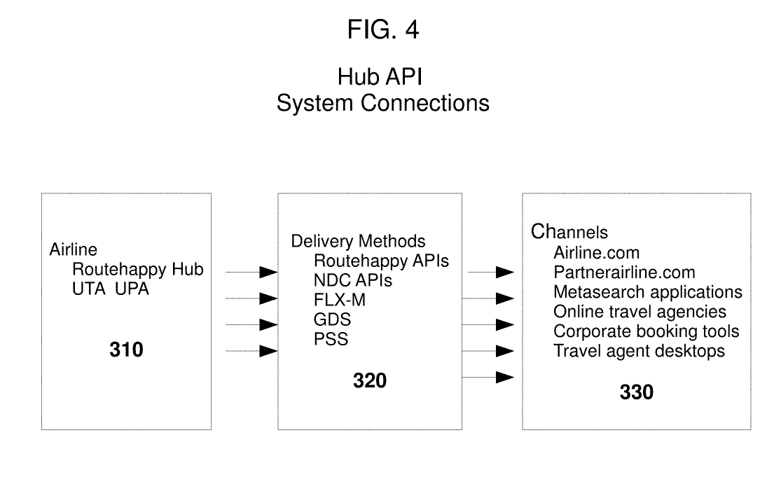

Referring now to FIG. 4, shown is a schematic of the Hub API System indicating relationships between Airline specific information (310), delivery methods (320) and channels of distribution (330). For each Airline (310) there may be access to the proprietary Hub to create and call upon specific UTA's and UPA's.

Referring now to box 320 in FIG. 4, the following definitions are relevant.
Routehappy API is a system providing methods to access data collections and distribute them to various channels across diverse platforms.
NDC (New Distribution Capability) is the emerging standard to facilitate airlines sharing of information about their services and products across multiple platforms to numerous distribution channels so that customers can have a transparent shopping experience. Reference is made for example to the Shopping schemas in NDC (EDIST) PADIS 16.2 Release Schemas.
FLX-M—FLX Merchandise, delivered as an Enterprise or cloud-based solution, is an airline-controlled merchandising and rules engine that allows airlines to create custom-tailored product and service offers for dynamic retail across multiple sales channels, including airline.com, mobile, check-in, kiosks, call centers, and travel agencies (direct or via GDS), all without hard coding and in a manner that is PSS, channel, and IBE-agnostic.
GDS—A Global Distribution System (GDS) is a network operated by a company that enables automated transactions between travel service providers (mainly airlines, hotels and car rental companies) and travel agencies.
PSS—A passenger service system (PSS) is a series of critical systems used by airlines. The PSS usually comprises an airline reservations system, an airline inventory system and a departure control system (DCS).
   Referring to Channels (330) in FIG. 4, the entities listed would be among the potential users of the Hub API.

### Examples of UPAs

Each UPA represents a single product attribute with descriptive text, an icon, photos, videos, and a link to more information. A service provider can showcase one's best brand and product attributes down to a single flight or across all flights. Two examples are provided below as they might be implemented on a web site being searched by a prospective customer.

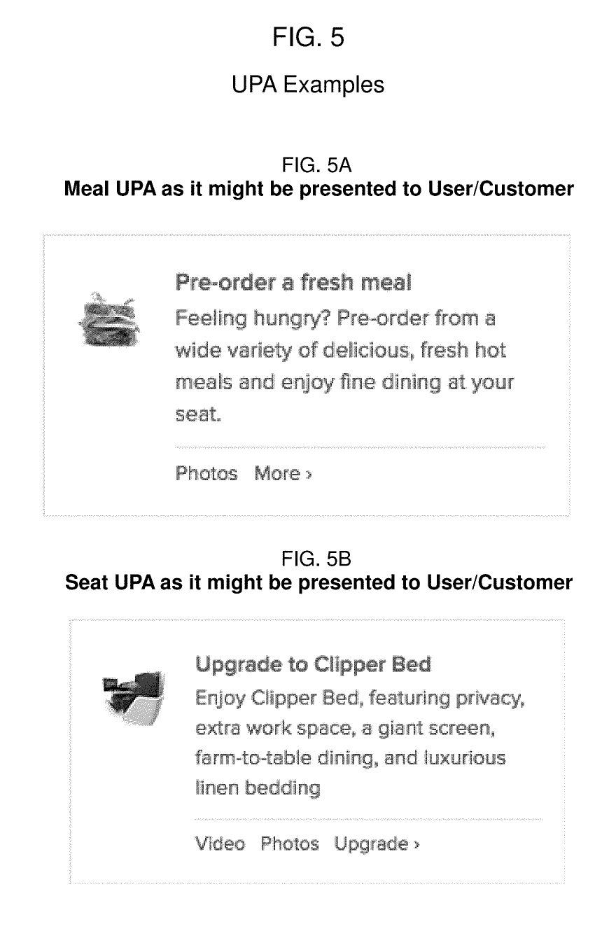

Referring now to FIG. 5A, is a display of a Meal UPA as it might be presented to a User/Customer. This might for example be targeted to flights departing after 12 noon and which are longer than 2 hours across several markets.

Referring now to FIG. 5B is a display of a Seat UPA as it might be presented to a User/Customer. This might be targeted to flights in specific markets on specific aircrafts; namely trans-continental flights on aircraft that have Clipper beds.

### Managing Media

Using the methods and means of the present invention, one can globally manage icons, photos, and videos associated with one's UPAs via a special database identified as the “Gallery.” (180) Media items added to the Gallery are immediately available for use in UPAs. Bulk file uploads are supported from a local file directory.

A method and means is provided so one can replace an existing icon, photo, or video at any point from the Gallery and so that replacing an item will cause the new asset to become associated with the UPAs the old one was previously linked to. Deleting an icon, photo, or video from the Gallery disassociates it with all UPAs it was previously linked to and removes it from the Gallery.

Adding media to UPAs allows flyers to visualize client products in a more meaningful way than text alone. The invention provides a method and means to incorporate a set of videos that will go far to influence and educate shoppers. Guidelines for content have been developed to ensure relevance and impact. Photos and videos may be associated with the actual product the flyer will experience. Captions are automatically copied over from the basic UPA caption, however, they can be overwritten to describe the media being displayed in more detail.

### Media Display Order

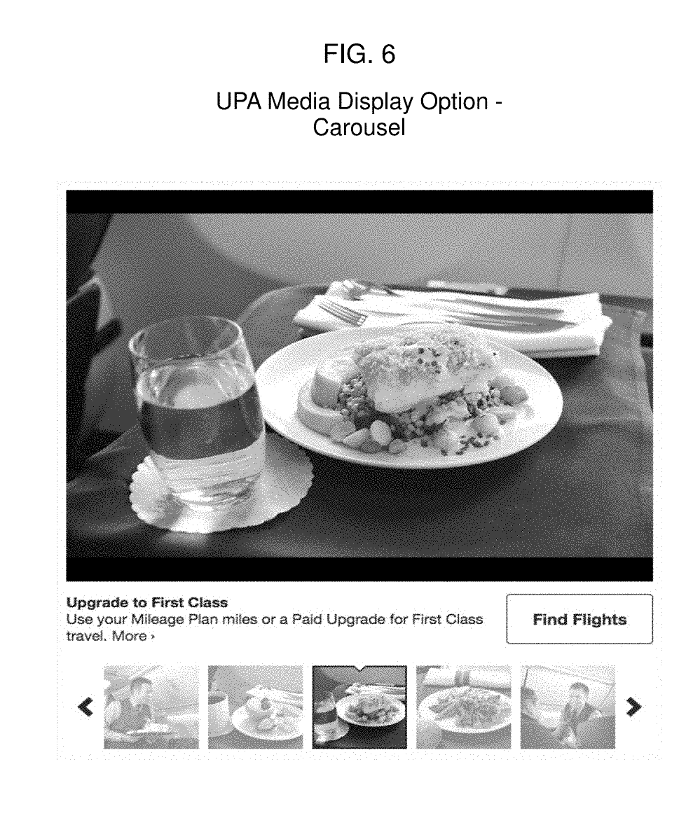

Since videos and photos tell the story of one's product in pictures, there is a means to alter the display order of the media. One can reorder photos or videos by dragging them up or down on the page. The ordering will be reflected in the photo and video sort order returned by the API and in the media window. See for example the optional carousel type display pictured at the bottom of FIG. 6.

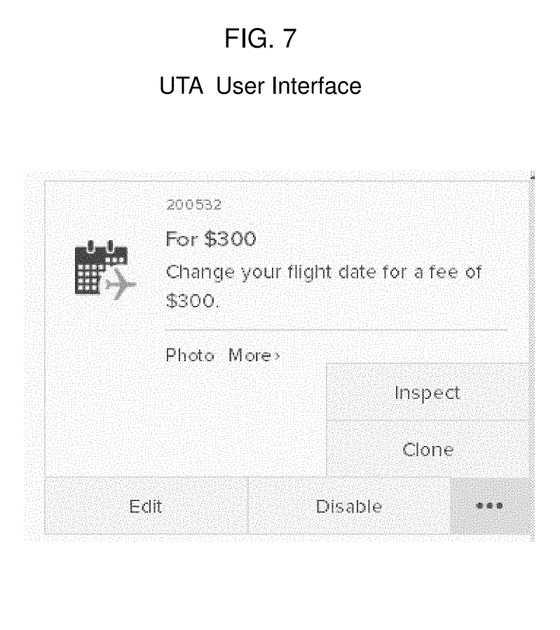

FIG. 7 is an example of a user interface for a UTA. Functionality includes an Edit mode, a Disable function, an Inspect mode and the ability to clone the UTA.

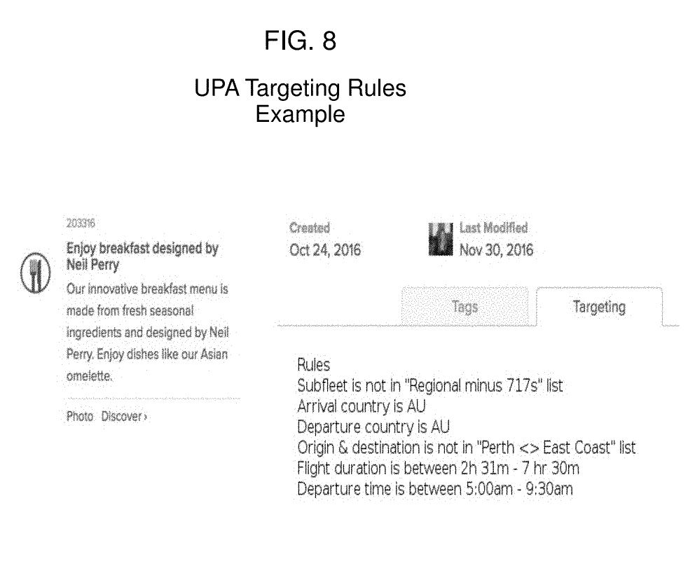

FIG. 8 is a depiction of the development of a UPA with the Targeting tab pressed to highlight the Rules. In this example a special breakfast is offered on flights in Australia that are at least 2.5 hours in duration and which occur in the early morning (5 am to 9:30 am). There is also a limitation on the aircraft.

### Lists

Lists (see 190 of FIG. 1) are collections of airports, countries, origin & destinations, subfleets, or terminals (targeting “criteria”) that one groups together to associate with targeting rules. Lists contain one or many items and can be edited at any time. The invention includes a method such that adding or removing items from an existing list will modify the targeting of all UPAs using that list. For example, if one were targeting a “Skis fly free” UPA to all flights arriving at ski locations across the US, you might create a list named “US ski locations” containing the relevant airports. When used in conjunction with other lists and targeting rules, the “Skis fly free” UPA would only appear on relevant flights during the right time of year. For client convenience, the available list content is scoped to the airports, countries, Origins & Destinations (O&Ds), etc.

### Filters

Once targeting attributes are implemented, the invention provides a means to use UPA view filters to ensure the UPAs appear in the right context. View filters allow for validating UPAs from the three perspectives indicated in Table 6.

TABLE 6
View Filters

| | |
|---|---|
| Airport | View UPAs explicitly targeted to one or many airports. UPAs |
| | can be viewed by geographic region or down to a single |
| | airport, depending on the targeting rules applied. |
| Aircraft | View UPAs explicitly targeted to one or many aircraft. UPAs |
| | can be viewed by subfleet or tail, depending on the targeting |
| | rules applied. |
| Flight | View all UPAs explicitly or implicitly targeted to a flight. |
| | Flights are restricted to nonstop carrier operated flights. |

### Translation

The inventive system involving a Hub further supports multilingual UPAs, manually translated from the primary (default) airline language to up to 39 languages. This capability lets one deliver UPAs in the appropriate language by point of sale. The process for translating UPAs is identical to the workflow for writing UPAs in the primary language.

All mandatory UPA Basics must be completed in the primary language and any other languages before submitting or publishing.

TABLE 7
Translatable fields

| Section | Field |
|---|---|
| Basics | Headline |
| | Description |
| | Call to action |
| | Call to action URL |
| Media | Caption(s) |

For convenience, the value of each field in the primary language is displayed inline.

### Hub API Resources

The following describes the resources that make up the Routehappy Hub API. The Hub API invention employs the structure of a JSON (JavaScript Object Notation) (http://jsonapi.org/) for handling mixed media. Other aspects of the invention are included to conform to various standards and best practices. Included among these are Authentication which is sent via the Auth header. A partner ID and API key is provided to the Subscriber user using the following code: Auth: PARTNER-ID:API-KEY.

Furthermore, all API requests support gzip and deflate HTTP compression. In the present embodiment to receive compressed response bodies, send the Accept-Encoding: gzip, deflate header. The type of compression used is indicated in the Content-Encoding response header.

### Legs Collection

To merge travel flight information with particular UPA's and passenger profiles, the method includes the pulling of flight legs data into the Targeting Engine. This endpoint is compliant with version 1.0 of the JSON API spec. Requests must include the header:

Accept: application/vnd.routehappy+json

The command for the Legs endpoint is:

GET /legs

Parameter details are listed in Table 8

TABLE 8
Parameter Details

| Name | Required | Description |
|---|---|---|
| filter[key] | Yes | Comma-delimited list of leg keys. |
| filter[category] | No | Comma-delimited list of category IDs. Used for filtering |
| | | UPAs and UTAs. For example, to return only |
| | | UPAs/UTAs having the standard category seat and |
| | | custom category children, send |
| | | filter [category]=seat, children. |
| include | No | Comma-delimited list of related resources to include. By |
| | | default, this endpoint does not return any related |
| | | resources. |
| gc[POSITION] | No | Used to specify the governing carrier for a leg. The |
| | | POSITION is the position (zero-based) of the leg key in the |
| | | filter[key] param. For example, gc[0]=DL&gc[2]=DL |
| | | sets the governing carrier to DL for the 1st and 3rd leg key. |

### Available Related Resources

Note: UTA/UPA fare types are filtered based on the requested cabins. For example, consider a UPA associated with Economy and Business fare types. If only Economy legs are requested, the UPA will be related only with the Economy fare type in the response.

utas

utas.fare_types

leg_segments

leg_segments.upas

leg_segments.upas.fare_types

leg_segments.upas.photo_attachments

leg_segments.upas.video_attachments

leg_segments.upas.tour_attachments

leg_segments.upas.photo_attachments.photo

leg_segments.upas.video_attachments.video

leg_segments.upas.tour_attachments.tour

### Response to Get Legs Command

A number of resource attributes that are part of the present invention are identified in greater detail in Table 9 which is a collection of smaller tables below.

TABLE 9
Resource Attributes Details
Resource Attributes

| Name | Type | Description |
|---|---|---|
| leg | | |
| key | string | Leg key |
| uta | | |
| headline | string | Headline, up to 40 characters |
| description | string | Description, up to 140 characters |
| small_icon_url | string | URL for the 42 × 42 icon |
| large_icon_url | string | URL for the 84 × 84 icon |
| cta_text | string | Link text for cta_url |
| cta_url | string | External URL where the end user can learn more |
| assessment | string | Possible values: neutral, benefit, restriction |
| categories | array | Elements are standard category IDs and/or custom |
| | | category IDs |
| fees | array | Additional fees. Elements are objects with members: |
| | | currency_code (string) |
| | | amount_min (string) |
| | | amount_max (string or null) |
| leg_segment | | |
| no attributes | | |
| upa | | |
| headline | string | Headline, up to 25 characters |
| description | string | Description, up to 125 characters |
| small_icon_url | string | URL for the 42 × 42 icon |
| large_icon_url | string | URL for the 84 × 84 icon |
| cta_text | string | Link text for cta_url |
| cta_url | string | External URL where the end user can learn more |
| categories | array | Elements are standard category IDs and/or custom category |
| | | IDs |
| fees | array | Additional fees. Elements are objects with members: |
| | | currency_code (string) |
| | | amount_min (string) |
| | | amount_max (string or null) |
| photo_attachment | | |
| caption | string | Photo caption |
| video_attachment | | |
| caption | string | Video caption |
| tour_attachment | | |
| caption | string | Tour caption |
| photo | | |
| thumb_url | string | URL to the 150 × 150 photo thumbnail |
| large_url | string | URL to the large photo (no wider than 800 px |
| | | and or taller than 600 px, scaled proportionately) |
| video | | |
| image_thumb_url | string | URL to the video thumbnail |
| embed_url | string | Used for construction of the embed code. |
| tour | | |
| image_thumb_url | string | URL to the tour thumbnail |
| embed_url | string | Used for construction of the embed code. |
| fare_type | | |
| name | string | Fare type name |
| rbds | array | RBD codes |

### Samples of Code for Implementing the Method

### Sample 1: Requesting UPAs

Universal Product Attributes (UPAs) describe all aspects of the tangible and intangible experience of a flight, targeted down to the flight cabin and further segmented by category and fare_type (fare brand and/or RBD code). Each UPA represents a single product attribute with descriptive text, an icon, photos, videos, virtual tours, and a link to more information. Below in Table 10 is an example request and response for requesting UPAs only.

TABLE 10
Code for Requesting UPA's

Request
curl \

```
-H “Auth: YOUR_API_KEY” \
-H “Accept: application/vnd.routehappy+json” \
-H “Accept-language: en” \
  -G \
  -d “filter [key]=YYC-YYZ-TS-882-20170911-ECON~YYZ-AMS-TS-
```

350-20170911-ECON” \

```
  -d “include=leg_segments.upas” \
  “YOUR_HOST/legs”
```

Response
{

“data”: [

{

“type”: “leg”,
“id”: “3361581-1~3360432-1”,
“attributes”: {

“key”: “YYC-YYZ-TS-882-20170911-ECON~YYZ-AMS-TS-

350-20170911-ECON”

},
“relationships”: {

“leg_segments”: {

“data”: [

{

“type”: “leg_segment”,
“id”: “3361581-1~3360432-1/0”

},
{

“type”: “leg_segment”,
“id”: “3361581-1~3360432-1/1”

}

]

}

}

}

],
“included”: [

{

“type”: “leg_segment”,
“id”: “3361581-1~3360432-1/0”,
“relationships”: {

“upas”: {

“data”: [

{

“type”: “upa”,
“id”: “200419”

},
...

]

}

}

},
{

“type”: “leg_segment”,
“id”: “3361581-1~3360432-1/1”,
“relationships”: {

“upas”: {

“data”: [

{

“type”: “upa”,
“id”: “200421”

},
...

]

}

}

},
{

“type”: “upa”,
“id”: “200415”,
“attributes”: {

“headline”: “Our redesigned cabin”,
“description”: “With a brand new Economy Class,

mood lighting and a personal entertainment system - it's a
whole new inflight experience.”,

“small_icon_url”:

“http://d13cihc9138cdj.cloudfront.net/icons/a67c9fa7-d915-
422f-8eff-e7ba938c566d/small/eco.png”,

“large_icon_url”:

“http://d13cihc9138cdj.cloudfront.net/icons/a67c9fa7-d915-
422f-8eff-e7ba938c566d/large/eco.png”,

“cta_text”: “More”,
“cta_url”: “http://www.airtransat.ca/en-CA/Travel-

information/Our-fleet/Our-redesigned-cabin”,

“categories”: [

“aircraft”,

],
“fees”: [
]

}

},

...

### Sample 2: Requesting UTAs

Universal Product Attributes (UTAs) are specific attributes of a fare, e.g. ticket refundability, structured using standardized terms and airline specific marketing language. As with UPAs, UTAs are targeted down to the flight cabin and further segmented by category and fare_type (fare brand and or RBD code). Each UTA represents a single ticket attribute with standardized headlines, descriptive text, an icon, and a link to more information. Below is an example request and response for requesting UTAs only.

TABLE 11
Code for Requesting UTA's

Request

curl \

```
  -H “Auth: YOUR_API_KEY” \
  -H “Accept: application/vnd.routehappy+json” \
  -H “Accept-language: en” \
  -G \
  -d “filter [key]=YYC-YYZ-TS-882-20170904-ECON~YYZ-
```

AMS-TS-350-20170904-ECON” \

```
  -d “include=utas, utas.fare_types” \
  “YOUR_HOST/legs”
```

Response
{

“data”: [

{

“type”: “leg”,
“id”: “3361868-1~3361754-1”,
“attributes”: {

“key”: “YYC-YYZ-TS-882-20170904-ECON~YYZ-AMS-TS-

350-20170904-ECON”

},
“relationships”: {

“utas”: {

“data”: [

{

“type”: “uta”,
“id”: “200532”

},
...

]

}

}

}

],
“included”: [

{

“type”: “fare_type”,
“id”: “51”,
“attributes”: {

“name”: “Eco”,
“rbds”: [
]

}

},
{

“type”: “fare_type”,
“id”: “54”,
“attributes”: {

“name”: “Eco Promo”,
“rbds”: [
]

}

},
{

“type”: “uta”,
“id”: “200532”,
“attributes”: {

“headline”: “For $300”,
“description”: “Change your flight date for a fee

of $300.”,

“small_icon_url”:

“http://d13cihc9138cdj.cloudfront.net/icons/09fc650a-57ab-
42f6-93fa-4a9ab4949d1f/small/flight_schedule.png”,

“large_icon_url”:

“http://d13cihc9138cdj.cloudfront.net/icons/09fc650a-57ab-
42f6-93fa-4a9ab4949d1f/large/flight_schedule.png”,

“cta_text”: “More”,
“cta_url”: “http://www.airtransat.ca/en/More-

flexibility-with-Eco-fares?ID=3186&type=gamme&tmpl=GEN”,

“assessment”: “neutral”,
“categories”: [

“advance-change”,
“ts”

],
“fees”: [

{

“currency_code”: “USD”,
“amount_min”: “300.00”,
“amount_max”: null

}

]

},
“relationships”: {

“fare_types”: {

“data”: [

{

“type”: “fare_type”,
“id”: “51”

},
{

“type”: “fare_type”,
“id”: “54”

}

]

}

}

},
...

]

}

### Fetching Related Resources

To include related resources, an include request parameter is added. This is a comma-delimited list of related documents. In the present implementation of the invention the available documents include at least the following:

upas

upas.videos

upas.photos

### Airlines Collection

The Hub API program gathers information on airlines from outside resources. The command is:

GET /airlines/:ids

This endpoint returns an airlines collection. :ids is a comma-delimited list of airline IDs. An airline ID is the IATA code (see box 112 of FIG. 2).
Other collections of data are comprised of

Legs

Itineraries

### Related Resources and Attributes

A further detail regarding the handling of the Airline information is the manner in which the data is stored in arrays. This is indicated in Table 12

TABLE 12
Airline Data Arrays

| Name | Description/Value set |
|---|---|
| Airline | |
| id | Airline IATA code. |
| upa_categories | An array of UPA category documents. Each |
| | document contains id and name. |
| fare_types | An array of fare type documents. Each document |
| | Contains id and name. |

### Standard Categories Collection

The standard category collection endpoint returns a UPA. The command is:

GET /upa_standard_categories

Resource attributes that are part of the present invention are identified in greater detail in Table 13 below.

TABLE 13
Resource Attributes Details
Resource Attributes

| Name | Description |
|---|---|
| data | |
| id | Unique identifier |
| name | Category name |

### System Responses

The system provides feedback to the user indicating the status of the program. The responses include the following shown in Table 14 below.

TABLE 14
System Responses

| Status code | Description |
|---|---|
| 200 | At least one resource exists for the given id(s). The body is |
| | a resource collection JSON document. |
| 404 | No resources exist for the given id(s). The body is a |
| | resource collection JSON document. |
| 401 | Incorrect authentication. The body is a JSON document. |
| 414 | URL is too long. Consider using the POST method with: |
| | ids in the request body. |
| 415 | Accept header is invalid. The body is a JSON |
| | document. |
| 400 | Generic client error. The body is an errors collection |
| | containing specific details. |
| 503 | The server is overloaded or down for maintenance. |
| | This is a temporary condition which will be alleviated |
| | after some delay. |
| 500 | The server encountered an unexpected condition which |
| | prevented it from fulfilling the request. This is a generic |
| | status code, given when no other specific status code |
| | is suitable. |

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be evident that the system may be implemented over the world wide web as well as through local networks and that the output can be to a variety of electronic devices including desktop computers, terminals, smartphones, laptops, tablets and the like. Similarly, data may be stored in computer electronic storage devices including but not limited to computers, local or remote servers, data drives, the cloud and the like.

What is claimed is:

1. A computer program product including a computer readable medium having computer program logic stored therein to provide a Hub with an Application Programming Interface (API) and method for collecting, developing, storing, managing, retrieving and distributing of mixed media content, herein named universal product attributes (UPAs) and universal ticketing attributes (UTAs). The Hub is comprised of a user Hub interface and the API is used for exchanging data stored within a database. The invention is further comprised of a means for associating rules with the UPAs and UTAs. The invention is further comprised of databases and structures and a means for associating UPAs and UTAs with data on airline schedules, flight attributes and travel amenities to produce one or more matches with customer interests using a rules-based matching engine.

2. The computer program product as in claim 1 is further comprised of a means for retrieving such data and matching at the level of each leg of a journey.

3. The computer program product as in claim 1 is further comprised of a platform user interface that provides a means for airlines and other service providers to create the UPA's and UTA's appropriate for their offerings.

4. The computer program product as in claim 1 that is further comprised of a means for filtering data according to aircraft, airport or flight.

5. A computer program product as in claim 1 that also includes a means to apply rules to produce raw data that can be exported across multiple platforms to produce linkages between itineraries and amenities.

6. Mixed media content as in claim 1 that includes one or more of photos, videos, graphics, text and electronically stored tours.

7. The rules-based matching engine of claim 1 that is comprised of
A map between scheduled flights and Published UPAs,
Associations by cabin and date,
Rules, Criteria, and operator sets,
Flight leg keys having a number of values.

8. The method for distribution of UPA's as in claim 1 that includes one or more of the following channels:
Airlines,
World Wide Web users,
Online Travel agents,
Corporate booking tools,
Business Partners and associates.

9. The method for developing UPA's and UTA's as in claim 1 that is further comprised of one or more of the following: an icon, a headline, a description, a Call to Action, a Call to action URL and an Additional cost factor.

10. The UTAs of claim 1 further comprised of one or more of the following categories:
Change,
Bag,
Seat,
Airline.

11. The UPAs of claim 1 further comprised of one or more of the following categories:
Flight,
Departure,
Connection,
Arrival,
Airline.

12. The computer program product as in claim 1 that includes methods to implement outputs across more than one platform and whose outputs can be viewed in diverse computing systems including but not limited to world wide web/Internet posted web-pages, LANs, dumb terminals, desktop computers, smartphones, laptops, notebooks and the like.

13. The Hub API as in claim 1, that is further comprised of a user interface comprised of control buttons with links to other system components such as UPA/UTA formation, gallery, lists, settings and user profile/log-in.

14. A system for travel planning comprising a computer readable medium having computer program logic stored therein and having a user Hub interface and an Application Programming Interface (API) used for exchanging data stored within a database that is managed by the Hub user interface. Said system allows the creation and collection of disparate sets of data and then matches those with interests of travelers using a rules-based matching engine. A further aspect of the invention is a method for collecting, developing, storing, managing, retrieving and distributing of mixed media content, herein named universal product attributes (UPAs) and universal ticketing attributes (UTAs). It is further comprised of a means for associating rules with the UPAs and UTAs.

15. The system of claim 14 that is further comprised of databases and structures and a means for associating UPAs and UTAs with data on airline schedules, flight attributes and travel amenities to produce one or more matches with customer interests using a rules-based matching engine.

16. The system of claim 14 that provides the means for airlines and other service providers to create the UPA's and UTA's appropriate for their offerings.

17. The system of claim 14 wherein the matching of data with interests of travelers can occur at the level of each leg of a journey.

18. The means for associating rules with UPAs and UTAs as in claim 14 that is further comprised of one or more of the following:
A map between scheduled flights and Published UPAs,
Associations by cabin and date,
Rules, criteria, and operator sets,
Flight leg keys having a number of values.

19. A computer enabled method comprising a user Hub interface and an Application Programming Interface (API) which is used exchanging data stored within a database that is managed by the user Hub interface. Such method provides for collecting, developing, storing, managing, retrieving and distributing of mixed media content, herein named universal product attributes (UPAs) and universal ticketing attributes (UTAs). The method is further comprised of a means for associating rules with the UPAs and UTAs. Said rules link UPAs and UTAs with data on airline schedules, flight attributes and travel amenities to produce one or more matches with customer interests using a rules-based matching engine.

20. The method of claim 19 is further comprised of a platform user interface that provides a means for airlines and other service providers to create the UPA's and UTA's appropriate for their offerings.
